(19) United States
(12) Patent Application Publication
(10) Pub. No.: US 2005/0040985 A1
(43) Pub. Date: Feb. 24, 2005

(54) System and method for providing improved accuracy relative positioning from a lower end GPS receiver

(76) Inventors: Trammell Hudson, Mt. Pleasant, SC (US); Dennis Bernardo D'Annunzio, Mt. Pleasant, SC (US)

Correspondence Address: MOORE & VAN ALLEN PLLC, P.O. BOX 13706, Research Triangle Park, NC, 27709, US

(21) Appl. No.: 10/711,051

(22) Filed: Aug. 19, 2004

Related U.S. Application Data
(60) Provisional application No. 60/496,138, filed on Aug. 19, 2003.

(51) Int. Cl. G01S 5/14

(52) U.S. Cl. 342/357.02

(57) ABSTRACT

A system for providing improved accuracy of global positioning information may include at least one sensor to acquire global position measurement information. The system may also include means to improve accuracy of the global position measurement information using noise and error information associated with the global position measurement information. In accordance with another embodiment of the present invention, a method for providing improved accuracy of global positioning information may include acquiring global position measurement information. The method may also include improving accuracy of the global position measurement information by using noise or error information associated with acquiring the global position measurement information.

### CROSS-REFERENCE TO RELATED APPLICATIONS

This application is related to U.S. provisional application No. 60/496,138, filed Aug. 19, 2003, entitled METHOD FOR PRODUCING HIGH ACCURACY RELATIVE POSITIONING FROM LOW COST GPS RECEIVER, GPS FILTER/OPTIMAL STATE ESTIMATOR naming Trammel Hudson and Dennis Bernardo D'Annunzio as the inventors. The contents of the provisional application are incorporated herein by reference in their entirety, and the benefit of the filing date of the provisional application is hereby claimed for all purposes that are legally served by such claim for the benefit of the filing date.

### BACKGROUND OF INVENTION

The present invention relates to geographical or global positioning and more particularly to a system and method for providing improved accuracy of relative positioning from a low cost global positioning system (GPS) or the like.

One application of a low cost GPS is unmanned vehicles, such as pilotless or unmanned aerial vehicles (UAVs) or the like, are being used in numerous and varied ways to provide solutions to various problems that may best be solved by an aerial platform, such as aerial photography, surveillance or similar activities. UAVs are relatively low cost to acquire and operate compared to full sized fixed wing aircraft or helicopters for such applications. UAVs can operate day or night and are insensitive to most hazardous environments, including smoke, toxins, gun fire or the like. Using longitude and latitude based coordinates, UAVs can repeatedly revisit the same geographic locations and altitudes to track construction programs or other projects from a consistent point of view. In order to effectively control the operation of such vehicles measuring or acquiring very precise or accurate relative global positioning information is needed. Some GPS receivers, particularly less expensive or lower end receivers that may be used in UAVs to keep the cost as low as possible, can result in inaccuracies in guiding the UAV to a particular location or returning to a particular location.

### SUMMARY OF INVENTION

In accordance with an embodiment of the present invention, a system for providing improved accuracy of global positioning information may include at least one sensor to acquire global position measurement information. The method may also include means to improve accuracy of the global position measurement information using noise or error information associated with the global position measurement information.

In accordance with another embodiment of the present invention, a system for providing improved accuracy of global positioning information may include at least one sensor to acquire global position measurement information and velocity measurement information. The system may also include means to improve accuracy of the global position measurement information and the velocity information using noise or error information associated with the global position measurement information and the velocity measurement information

In accordance with another embodiment of the present invention, a system for providing improved accuracy of global positioning information to control operation of a vehicle may include a system for providing global positioning information. The system may also include an attitude and heading reference system (AHRS) and a controller to receive data from the AHRS and the system for providing global positioning information to control operation of the vehicle.

In accordance with another embodiment of the present invention, an unmanned vehicle may include a housing member and at least one sensor to acquire global positioning measurement information contained in the housing member. The unmanned vehicle may also include means to improve accuracy of the global position measurement information using noise or error information associated with the global position measurement information.

In accordance with another embodiment of the present invention, a method for providing improved accuracy of global positioning information may include acquiring global position measurement information. The method may also include improving accuracy of the global positioning measurement information by using noise or error information associated with acquiring the global position measurement information.

In accordance with another embodiment of the present invention, a method to control movement of a vehicle may include acquiring global position measurement information and improving accuracy of the global position measurement information by using noise or error information associated with the global position measurement information. The method may also include controlling movement of the vehicle in response to the improved accuracy of the global position measurement information.

In accordance with another embodiment of the present invention, a method of making a system for providing improved accuracy of global positioning information may include providing at least one sensor to acquire global position measurement information. The method may also include providing means to improve accuracy of the global position measurement information using noise or error information associated with the global position measurement information.

In accordance with another embodiment of the present invention, a method of making an unmanned vehicle may include providing a housing member. The method may also include attaching at least one sensor to the housing member to acquire global position measurement information. The method may also include providing means to improve accuracy of the global position measurement information using noise or error information associated with the global position measurement information.

### BRIEF DESCRIPTION OF DRAWINGS

FIG. 1 is an exemplary system for providing improved global positioning information that may be used to control operation of a vehicle in accordance with an embodiment of the present invention.

FIG. 2 is a flow chart of an exemplary method for providing improved accuracy of global positioning information in accordance with an embodiment of the present invention

FIG. 3 is a flow chart of an exemplary method for providing improved accuracy of global positioning information and for controlling operation of a vehicle in accordance with an embodiment of the present invention.

### DETAILED DESCRIPTION

The following detailed description of preferred embodiments refers to the accompanying drawings which illustrate specific embodiments of the invention. Other embodiments having different structures and operations do not depart from the scope of the present invention.

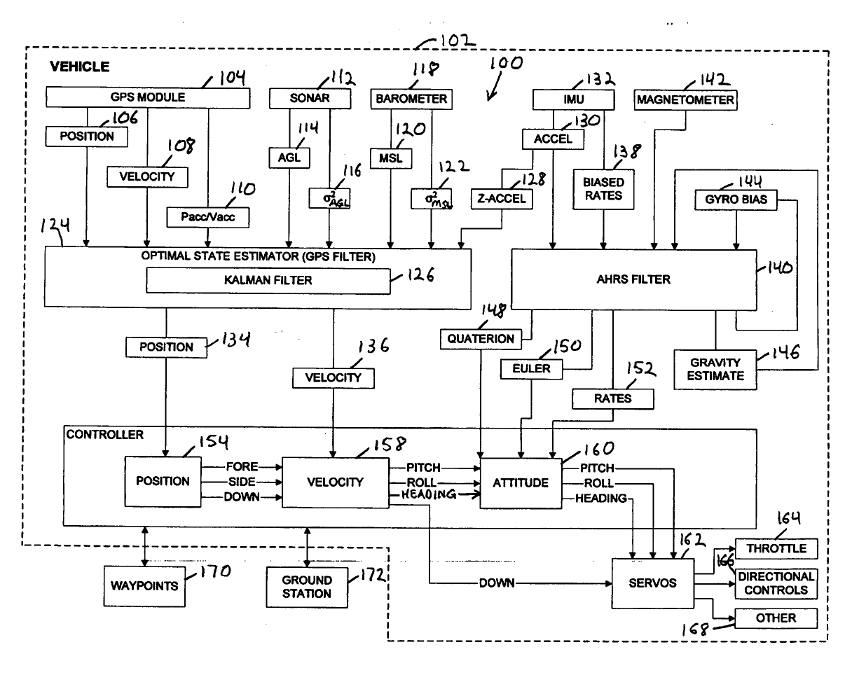

FIG. 1 is an exemplary system 100 for providing improved global positioning information that may be used to control operation of a vehicle 102 in accordance with an embodiment of the present invention. The system 100 for providing improved accuracy of global positioning information may include at least one sensor 104 to acquire global position measurement information. The sensor 104 may include a global positioning system (GPS) module or the like. The sensor 104 or GPS module may provide global position measurement information 106 and velocity measurement information 108. The sensor 104 or GPS module may also provide noise or error information associated with the global position measurement information and the velocity measurement information. The noise or error information associated with the global position measurement information and the velocity measurement information may be represented as position accuracy (Pacc) and velocity accuracy (Vacc) information 110 or data in FIG. 1. The Pacc and Vacc information 110 or noise and error information may be the result of receiver clock skew, vibration of the vehicle, air pressure, air temperature, wind direction and velocity, ionospheric conditions, humidity and the like. The Pacc and Vacc information 110 may be estimates of the actual noise or error information taking into consideration the different variables that may affect the GPS and velocity measurements.

The system 100 may also include a sonar sensor 112 or similar device or sensor to perform an above ground level (AGL) measurement 114 and to provide a standard deviation 116 (σ²_{AGL}) associated with the AGL measurement 114. The system 100 may also include a barometer 118 or air pressure sensor or device to perform a mean sea level (MSL) measurement 120 and to provide a standard deviation 122 (σ²_{MSL}) associated with the MSL measurement 120.

The system 100 may also include an optimal state estimator 124 or other means to improve accuracy of the global position measurement information 106 (and in the embodiments of the present invention shown in FIG. 1, also the velocity measurement 108) using noise and error information or estimates associated with the global position measurement information 106 and velocity measurement information 108. The optimal state estimator 124 may receive as inputs the global position measurement information 106, velocity measurement information 108 and the noise or error information or estimates Pacc/Vacc 110. The optimal state estimator 124 may also receive as inputs the AGL measurement 114 and associated standard deviation (σ²_{AGL}) and the MSL measurement 120 and associated standard deviation (σ²_{MSL}). The optimal state estimator 124 may also receive a z-axis acceleration input (z-accel) 128 or vertical component of a measurement 130 of acceleration. The acceleration measurement 130 may be measured by an inertial measurement unit (IMU) 132. An example of the IMU 132 may be a Revision 2.4 6DOF IMU Kit or Assembly as manufactured by Rotomotion, LLC of Mt. Pleasant, S.C. or a similar IMU device. The optimal state estimator 124 or means to improve accuracy of the global position measurement and the velocity measurement information may be embodied in a global positioning system (GPS) filter. The optimal state estimator 124 or GPS filter may include a Kalman filter 126. The GPS filter including the Kalman filter 126 may automatically weigh the sensor measurement information based on the noise or error information or estimates of noise or measurement errors to improve the accuracy of the global position measurement information and the velocity measurement information. Accordingly, the GPS filter including the Kalman filter 126 may form the optimal state estimator 124 to provide a weighted state estimate of the global position measurement information and velocity measurement information using the noise and error information or estimates. With use of the optimal state estimator 124 or Kalman filter 126, a lower end and less expensive GPS module 124 may be used but very precise relative position measurement information and velocity measure information can be derived or determined for controlling operation of the vehicle 102. The weighted state estimate of the relative position measurement information and velocity measurement information provides an improved or higher accuracy relative positioning measurement 134 and velocity measurement 136 by using or applying the noise and error information in the Kalman filter 126 compared to the position measurement information 106 and velocity measurement information 108 from the GPS module 104.

The multiple sensors, such as the GPS module 104, sonar sensor 112, barometer 118 and IMU 132, provide measurements of overlapping information associated with the position estimate and velocity. Each of the multiple sensors include different error, noise and accuracy characteristics in performing measurements which may be utilized or taken advantage of in the optimal state estimator 124 or Kalman filter 126 in providing the improved or higher accuracy global position measurement information and velocity measurement information.

In describing the operation or function of the optimal state estimator 124 or Kalman filter 126 as applied to the present invention, the Kalman filter 126 may use a state vector equation that may be characterized as a static propagation equation for discrete or continuous time steps:

$$Equation 2 : \\ \underline{x = [ \begin{matrix}N \\ E \\ D \\ VN \\ VE \\ VD\end{matrix} ]}$$

In equation 1, the state variable x is the position and velocity estimates, which may be defined by the matrix:

$$Equation 1 : \\ \underline{x = x + {x}^{′} dt}$$

N, E and D may define the three dimensional coordinate or global location of the vehicle 102. For example, N may correspond to a north/south location in the local tangent plane or a polar latitude, E may correspond to an east/west location in the local tangent plane or a polar longitude, and D to an altitude above or below the local tangent plane, or to an altitude above MSL, or to an altitude above AGL. VN, VE and VD may correspond to variations in each of the three dimensional coordinates defining the location.

In equation 1, x′ is the first derivative of the state vector x and is defined by the vector of measurements:

$$Equation 3 : \\ \underline{{x}^{′} = [ \begin{matrix}VN \\ VE \\ \begin{matrix}VD \\ 0 \\ 0 \\ Zaccel\end{matrix}\end{matrix} ]}$$

Zaccel 128 is the z-axis component or the vertical component of the acceleration measurement 130 from the IMU 130 as previously described, once it has been rotated into the local tangent plane reference frame.

The state propagation equation can be used in a Kalman filter or other optimum state estimator as described in Fundamentals of Kalman Filtering: A Practical Approach by Paul Zarchan and Howard Musoff (AIM 2000).

The IMU 132 may also generate or provide biased body frame rotational rates 138. The low cost angular rate sensors have a time varying DC offset in their output that must be removed before the output can be used as a body frame rotational rate. The acceleration measurement 130 and the biased rated 138 may be applied to an attitude and heading reference system (AHRS) filter 140 or the like. The AHRS 140 may be an AHRS200A or the like as manufactured by Rotomotion, LCC of Mt. Pleasants, S.C.

The system 100 may also include a magnetometer 142 to measure the magnetic field of the earth or provide a compass heading or orientation of the vehicle 102 relative to the earth's magnetic field. The output of the magnetometer 142 may also be applied to the AHRS filter 140. A gyro bias signal or measurement 144 and a gravity estimate 146 may be generated by the AHRS filter 140 and fed back to the AHRS filter 140. The AHRS filter 140 may generate a quaternion output signal 148, Euler output signals 150 and angular rate signals 152. The quaternion output signal 144 is equivalent to the Euler angle measurement, but does not have the discontinuities at extreme angles or gymbal lock. The Euler output signals 146 may represent vectors corresponding to pitch, roll and heading angles of the vehicle relative to the local tangent plane 102 and the rotational rates signals 148 may be signals corresponding to rates of change of any of the vectors.

The improved or higher accuracy global position measurement information 134 from the optimal state estimator 124 may be applied to a position control portion 154 of a controller 156. The position control portion 154 may control the global positioning of the vehicle 102 with respect to latitude, longitude and altitude. The position control portion 154 may generate north, east and down control signals or body frame relative forwards (FORE), sideways (SIDE) and down (DOWN) control signals.

The improved or higher accuracy velocity measurement information 136 from the optimal state estimator 124 may be applied to a velocity control portion 158 of the controller 156. The velocity control portion 158 may also receive the north, east, and down control signals or global positioning information and altitude information from the position control portion 154. The velocity control portion 158 may generate revised roll angle (φ), pitch angle (θ), and down control signals in response to the improved velocity measurement information or signal 136 and the control signals from the position control portion 154.

The quaternion 148 or Euler 150 and angular rates 152 signals from the AHRS 140 may be applied to an attitude control portion 160 of the controller 156. The attitude control portion 160 may also receive the φ, θ, and heading (ψ) control signals from the velocity control portion 158. The attitude control portion 160 may generate pitch, roll and heading control signals. The pitch, roll and heading control signals form the attitude control portion 160 may be applied to servo motors 162. The down control signal from the velocity control portion 158 may also be applied to one or more of the servo motors 162. The servo motors 162 may control a throttle 164, directional controls 166, such as control surfaces on an aeronautical or aerospace vehicle or other controls or devices 168 that may be used to control movement or operation of the vehicle 102. The vehicle 102 may be an aerospace or aeronautical vehicle, such as a robotic fixed wing aircraft, helicopter or rotorcraft. The vehicle 102 may also be a terrestrial vehicle or watercraft, such as a submersible or the like.

Waypoints (North, East, Down, ψ) 170 or geographic locations (Latitude, Longitude, Altitude, ψ) or local tangent plane relative (ΔN, ΔE, ΔD, Δψ) or body frame relative (ΔX, ΔY, ΔZ, Δψ) or any combination thereof may be loaded into the controller 156. The waypoints 170 may be preloaded into the controller 156 or transmitted to the controller 156 while the vehicle 102 is in operation. In this manner a predetermined mission can be programmed into the controller 156 and be modified or changed during a mission or operation.

The controller 156 may also receive signals from a ground station 172 or remote station that may control operation of the vehicle 102. The ground station may be used to program the controller 156 and add or delete waypoints 170 during operation of the vehicle 102.

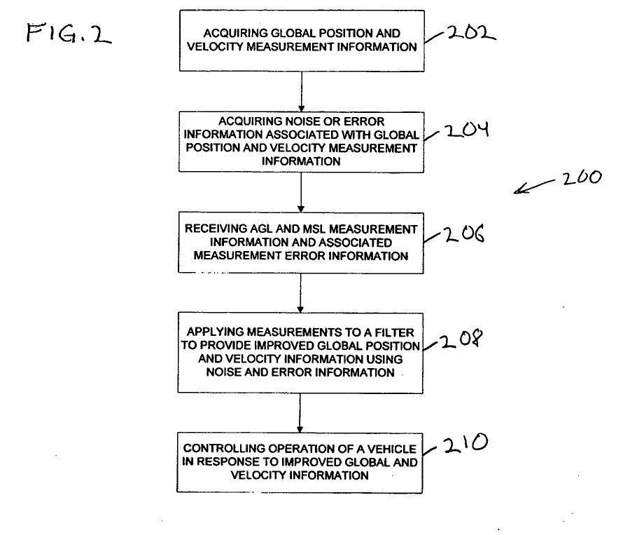

FIG. 2 is a flow chart of an exemplary method 200 for providing improved accuracy of global positioning information in accordance with an embodiment of the present invention. The method 200 may be embodied in a system, such as the system 100 of FIG. 1. In block 102, global position and velocity measure information may be acquired. As discussed with respect to FIG. 1, the global position and velocity information may be acquired by the GPS module 104 or the like. The GPS module 104 may be a relatively simple or lower end GPS module. In another embodiment of the present invention, only global position measurement information may be acquired.

In block 204, noise and error information associated with the global position measurement information and velocity measurement information may be acquired. The noise and error information may include information relative to position accuracy (Pacc), velocity accuracy (Vacc) or other noise or error information, either generated by the sensor itself or as part of the external analysis of the measurements. In block 206, above ground level (AGL) measurement information, mean sea level (MSL) measurement information, standard deviations relative to the AGL and MSL measurements, a vertical or z component of an acceleration vector or similar measurements and noise and error information from different sensors may be acquired.

In block 208, the measurements from blocks 204 and 208 and measurements from any other sensors that may be used in an optimal state estimator to provide an improved or more accurate global position measurement or velocity measurement may be applied to a filter or optimal state estimator. The filter or optimal state estimator may provide an improved relative accuracy global position measurement or velocity measurement using the noise and error information acquired in blocks 204 and 206.

In block 210, a vehicle may be controlled in response to the improved global position measurement information and velocity information. The vehicle may be controlled similar to that described with respect to FIG. 1.

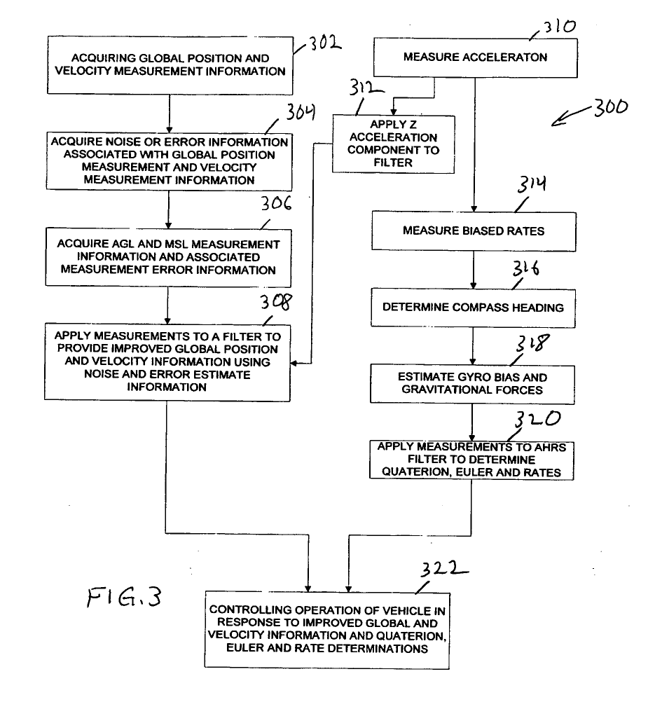

FIG. 3 is a flow chart of an exemplary method 300 for providing improved accuracy of global positioning information and for controlling operation of a vehicle in accordance with another embodiment of the present invention. The method 300 may be embodied in a system such as the system 100 of FIG. 1. In block 302, global position measurement information and velocity measurement information may be acquired. The information may be acquired similar to that previously described with respect to FIGS. 1 and 2.

In block 304, noise or error information associated with the global position measure information and velocity measurement information may be acquired. In block 306, AGL and MSL measurement information and noise and error information associated with the AGL and MSL measurements may be acquired. Similar parameters or measurements and error information may also be acquired that may facilitate providing an improved or more accurate global position information or velocity information when applied to an optimal state estimator or Kalman filter.

In block 308 the measurements from blocks 304 and 306 may be applied to a filter or optimal state estimator to provide improved global position and velocity measurement information using the noise and error information.

In block 310, acceleration may be measured. In block 312, a z-component of the acceleration may be applied to the filter along with the other measurements and error information in block 308. In block 314, biased angular rates may be measured or determined. In block 316, a compass heading of the vehicle may be determined or an orientation relative to the earth's magnetic field may be determined. In block 318, gyro bias and gravitational forces may be estimated or determined. In block 320, the measurements or results from blocks 314-318 may be applied to an attitude and heading reference system (AHRS) to provide quaternion, Euler signals and rates of change signals associated with the quaternion and Euler signals.

In block 322, operation of a vehicle may be controlled in response to the improved accuracy or higher accuracy of the global position and velocity measurement information from block 308 and the quaternion, Euler and rate information or results from the AHRS in block 320.

While the present invention has been described with respect to a vehicle, the present invention may have application in any positioning or navigation application or environment, such as pedestrian navigation or the like.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

1. A system for providing improved accuracy of global positioning information, comprising:
at least one sensor to acquire global position measurement information; and
means to improve accuracy of the global position measurement information using noise and error information associated with the global position measurement information.

2. The system of claim 1, further comprising multiple sensors to measure overlapping information associated with global positioning, wherein each of the multiple sensors includes different error, noise and accuracy characteristics in performing measurements which are utilized in providing the improved accuracy of the global position measurement information.

3. The system of claim 1, wherein means to improve accuracy of the global position measurement information comprises a filter to automatically weigh the global position measurement information based on the noise and error information associated with the global position measurement information.

4. The system of claim 1, wherein means to improve accuracy of the global position measurement information comprises an optimal state estimator to provide a weighted state estimate of the global position measurement information using the noise and error information.

5. The system of claim 1, wherein the means to improve accuracy of the global position measurement information comprises a global positioning system filter.

6. The system of claim 1, wherein the means to improve accuracy of the global position measurement information comprises a Kalman filter.

7. The system of claim 1, further comprising:
a sonar sensor to perform an above ground level (AGL) measurement and to provide a standard deviation of the AGL measurement; and
a barometric sensor to perform a mean sea level (MSL) measurement and to provide a standard deviation of the MSL measurement.

8. The system of claim 1, further comprising a sensor to measure acceleration, wherein at least a z-axis or altitude acceleration component of the measured acceleration is applicable to the means to improve accuracy of the global position measurement information.

9. The system of claim 1, wherein the at least one sensor to acquire global position measurement information comprises a global positioning system module.

10. A system for providing improved accuracy of global positioning information, comprising:
at least one sensor to acquire global position measurement information and velocity measurement information; and
means to improve accuracy of the global position measurement information and the velocity measurement information using noise and error information associated with the global position measurement information and the velocity measurement information.

11. The system of claim 10, further comprising multiple sensors to measure overlapping information associated with global positioning and velocity, wherein each of the multiple sensors includes different error, noise and accuracy characteristics in performing measurements which are utilized in providing the improved accuracy of the global position measurement and velocity measurement information.

12. The system of claim 10, wherein the means to improve accuracy of the global position measurement information and velocity measurement information comprises a filter to automatically weigh the global position measurement information and velocity measurement information based on the noise and error information associated with the global position measurement information and velocity measurement information.

13. The system of claim 10, wherein the means to improve accuracy of the global position measurement information and velocity measurement information comprises a Kalman filter.

14. The system of claim 10, further comprising:
a sonar sensor to perform an above ground level (AGL) measurement and to provide a standard deviation of the AGL measurement; and
a barometric sensor to perform a mean sea level (MSL) measurement and to provide a standard deviation of the MSL measurement.

15. A system for providing improved accuracy of global positioning information to control operation of a vehicle, comprising:
a system for providing global positioning information;
an attitude and heading reference system (AHRS); and
a controller to receive data from the AHRS and the system for providing global positioning information to control operation of the vehicle.

16. The system of claim 15, wherein the system for providing global positioning information comprises:
at least one sensor to acquire global position measurement information and velocity measurement information; and
means to improve accuracy of the global position measurement information and the velocity measurement information using noise and error information associated with measuring the global position measurement information and the velocity measurement information.

17. The system of claim 16, further comprising multiple sensors to measure overlapping information associated with global positioning and velocity measurement, wherein each of the multiple sensors includes different error, noise and accuracy characteristics in performing measurements which are utilized in providing the improved accuracy of the global position measurement information and velocity measurement information.

18. The system of claim 16, wherein the means to improve accuracy of the global position measurement information and velocity measurement information comprises an optimal state estimator to automatically weigh the global position measurement information and the velocity measurement information based on the noise and error information associated with the global position measurement information.

19. The system of claim 16, wherein the means to improve accuracy of the global position measurement information and the velocity measurement information comprises a GPS filter including a Kalman filter.

20. The system of claim 16, further comprising:
a sonar sensor to perform an above ground level (AGL) measurement and to provide a standard deviation of the AGL measurement; and
a barometric sensor to perform a mean sea level (MSL) measurement and to provide a standard deviation of the MSL measurement.

21. The system of claim 16, wherein the at least one sensor to acquire global position measurement information and velocity measurement information comprises a global positioning system module.

22. The system of claim 16, wherein the at least one sensor comprises an inertial measurement unit to measure acceleration, wherein at least a z-axis or vertical component of acceleration is applicable to the means to improve accuracy of the global position measurement information and the velocity measurement information.

23. The system of claim 15, further comprising an inertial measurement unit to measure acceleration for use by the system for providing global positioning information and for use by the AHRS.

24. An unmanned vehicle, comprising:
a housing member;
at least one sensor to acquire global positioning measurement information contained in the housing member; and
means to improve accuracy of the global position measurement information using noise and error information associated with the global position measurement information.

25. The unmanned vehicle of claim 24, further comprising multiple sensors to measure overlapping information associated with global positioning, wherein each of the multiple sensors includes different error, noise and accuracy characteristics in performing measurements which are utilized in providing the improved accuracy of global position measurement information.

26. The unmanned vehicle of claim 24, wherein the means to improve accuracy of the global position measurement information comprises a filter to automatically weigh the global position measurement information based on the noise and error information associated with the global position measurement information.

27. The system of claim 24, wherein the means to improve accuracy of the global position measurement information comprises a Kalman filter.

28. The unmanned vehicle of claim 24, further comprising:
a sonar sensor to perform an above ground level (AGL) measurement and to provide a standard deviation of the AGL measurement; and
a barometric sensor to perform a mean sea level (MSL) measurement and to provide a standard deviation of the MSL measurement.

29. The unmanned vehicle of claim 24, further comprising a sensor to measure acceleration, wherein at least a z-axis or vertical component of an acceleration vector is applicable to the means to improve accuracy of the global position measurement information.

30. The unmanned vehicle of claim 24, further comprising:
an AHRS; and
a controller to receive signals from the AHRS and the means to improve accuracy of the global position measurement information to control movement of the unmanned vehicle.

31. The unmanned vehicle of claim 30, wherein the controller is adapted to receive to receive other signals, wherein the other signals comprise signals including waypoint information and signals from a remote station.

32. A method for providing improved accuracy of global positioning information, comprising:
acquiring global position measurement information; and
improving accuracy of the global position measurement information by using noise and error information associated with acquiring the global position measurement information.

33. The method of claim 32, further comprising:
acquiring velocity measurement information; and
improving accuracy of the velocity measurement information by using noise and error information associated with acquiring the velocity measurement information.

34. The method of claim 32, further comprising measuring overlapping information associated with global positioning using different sensors, wherein each of the different sensors includes different error, noise and accuracy characteristics in performing measurements which are utilized in providing the improved accuracy of the global position measurement information.

35. The method of claim 32, further comprising acquiring AGL and MSL measurement information and associated error and noise information.

36. The method of claim 32, further comprising applying the global position measurement information and noise and error information to a filter to provide the improved accuracy of the global position measurement information.

37. The method of claim 32, further comprising applying the global position measurement information and noise and error information to a Kalman filter to provide the improved accuracy of the global position measurement information.

38. The method of claim 32, further comprising controlling operation of a vehicle in response to the improved accuracy of the global position measurement information.

39. A method to control movement of a vehicle, comprising:
acquiring global position measurement information;
improving accuracy of the global position measurement information by using noise and error information associated with the global position measurement information; and
controlling movement of the vehicle in response to the improved accuracy of the global position measurement information.

40. The method of claim 39, further comprising:
acquiring velocity measurement information; and
improving accuracy of the velocity measurement information by using noise and error information associated with the velocity measurement information.

41. The method of claim 39, further comprising measuring overlapping information associated with global positioning using different sensors, wherein each of the different sensors includes different error, noise and accuracy characteristics in performing measurements which are utilized in improving the accuracy of the global position measurement.

42. The method of claim 39, further comprising acquiring AGL and MSL measurement information and associated error and noise information.

43. The method of claim 39, further comprising applying the global position measurement information to a filter to improve accuracy of the global position measurement information using the noise and error information.

44. The method of claim 39, further comprising applying the global position measurement information to a Kalman filter to provide the improved accuracy of the global position measurement information using the noise and error information.

45. A method of making a system for providing higher accuracy global positioning information, comprising:
providing at least one sensor to acquire global position measurement information; and
providing means to improve accuracy of the global position measurement information using noise and error information associated with the global position measurement information.

46. The method of claim 45, further comprising providing multiple sensors to measure overlapping information associated with global positioning, wherein each of the multiple sensors includes different error, noise and accuracy characteristics in performing measurements which are utilized in providing the improved accuracy of the global position measurement information.

47. The method of claim 45, wherein means to improve accuracy of the global position measurement information comprises a filter to automatically weigh the global position measurement information based on the noise and error information associated with the global position measurement information.

48. The method of claim 45, wherein means to improve accuracy of the global position measurement information comprises a Kalman filter.

49. The method of claim 45, further comprising:
providing a sonar sensor to perform an above ground level (AGL) measurement and to provide a standard deviation of the AGL measurement; and
providing a barometric sensor to perform a mean sea level (MSL) measurement and to provide a standard deviation of the MSL measurement.

50. A method of making an unmanned vehicle, comprising:
providing a housing member;
attaching at least one sensor to the housing member to acquire global position measurement information; and
providing means to improve accuracy of the global position measurement information using noise and error information associated with the global position measurement information.

51. The method of claim 50, further comprising providing multiple sensors to measure overlapping information associated with the global positioning, wherein each of the multiple sensors includes different error, noise and accuracy characteristics in performing measurements which are utilized in providing the more accurate global position measurement information.

52. The method of claim 50, further comprising providing means to improve accuracy of the global position measurement information comprises a filter to automatically weigh the global position measurement information based on the noise and error information associated with the global position measurement information.
